(19) United States
(12) Patent Application Publication
(10) Pub. No.: US 2023/0377472 A1
(43) Pub. Date: Nov. 23, 2023

(54) METHOD AND SYSTEM FOR PROVIDING INCENTIVIZED ONLINE LEARNING

(71) Applicant: LearnROI, Inc., Nashville, TN (US)

(72) Inventors: Matthew MASCOLO, Denver, CO (US); Jackson TAYLOR, Nashville, TN (US)

(21) Appl. No.: 18/132,701

(22) Filed: Apr. 10, 2023

Related U.S. Application Data
(60) Provisional application No. 63/329,046, filed on Apr. 8, 2022.

(51) Int. Cl. G09B 5/02; G06Q 10/1053

(52) U.S. Cl. CPC G09B 5/02; G06Q 10/1053

(57) ABSTRACT

An approach for incentivizing online learning is disclosed. The approach comprises registering a plurality of users to establish a corresponding plurality of user accounts. The approach further comprises enrolling the plurality of users into one or more courses. The approach further comprises collecting performance information of the plurality of users for the one or more courses. The approach also comprises determining ranking of the plurality of users based on the performance information. The approach further comprises attributing reward credits to one or more of the plurality users according to the ranking; and selectively applying the reward credits to the plurality of user accounts based on the attribution.

### RELATED APPLICATION

This application claims priority of U.S. Provisional Patent Application Ser. No. 63/329,046, entitled “METHOD AND SYSTEM FOR PROVIDING INCENTIVIZED ONLINE LEARNING,” filed on Apr. 8, 2022, the contents of which are hereby incorporated herein in their entirety by this reference.

### BACKGROUND

Online learning (or e-learning) continues to grow in popularity, offering great flexibility in scheduling and time for completion of courses/programs. E-learning has emerged as an effective means for educational institutions having a physical presence in a certain geographic location to expand their reach to enroll students in other geographical areas. Additionally, these educational institutions can deploy a virtual classroom with relative ease should circumstances require—e.g., health and safety, natural disasters, etc. Areas well suited for e-learning include vocational training and training certifications, which have been made accessible and affordable to students who wish to develop a new skill, whereby they can augment their opportunities for employment. Unfortunately, in a virtual environment without a physical classroom and the continual guidance of a teacher, students can lose concentration and motivation to learn. From a technological perspective, conventional computing platforms lack creation of a virtual environment that overcome these drawback with students ability to learn.

### SOME EXAMPLE EMBODIMENTS

Therefore, there is a need for an approach that incentivizes students in an online learning environment and accurately assesses the resultant skills.

According to one embodiment, a method comprises registering a plurality of users to establish a corresponding plurality of user accounts. The method further comprises enrolling the plurality of users into one or more courses. The method further comprises collecting performance information of the plurality of users for the one or more courses. The method also comprises determining ranking of the plurality of users based on the performance information. The method further comprises attributing reward credits to one or more of the plurality users according to the ranking; and selectively applying the reward credits to the plurality of user accounts based on the attribution.

According to another embodiment, an apparatus comprises at least one processor, and at least one memory including computer program code for one or more computer programs, the at least one memory and the computer program code configured to, with the at least one processor, cause, at least in part, the apparatus to register a plurality of users to establish a corresponding plurality of user accounts. The apparatus is also caused to enroll the plurality of users into one or more courses. The apparatus is also caused to collect performance information of the plurality of users for the one or more courses. The apparatus is also caused to determine ranking of the plurality of users based on the performance information. The apparatus is further caused to attribute reward credits to one or more of the plurality users according to the ranking; and to selectively apply the reward credits to the plurality of user accounts based on the attribution.

According to another embodiment, a non-transitory computer-readable storage medium carries one or more sequences of one or more instructions which, when executed by one or more processors, cause, at least in part, an apparatus comprises means for registering a plurality of users to establish a corresponding plurality of user accounts. The apparatus also caused to comprises means for enrolling the plurality of users into one or more courses. The apparatus also comprises means for collecting performance information of the plurality of users for the one or more courses. The apparatus comprises means for determining ranking of the plurality of users based on the performance information. The apparatus further comprises means for attributing reward credits to one or more of the plurality users according to the ranking; and means for selectively applying the reward credits to the plurality of user accounts based on the attribution.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between the service provider and mobile device with actions being performed on both sides.

For various example embodiments, the following is applicable: An apparatus comprising means for performing a method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of online learning platform, according to one embodiment;

FIG. 2 is a diagram of the components of the online learning platform of FIG. 1, according to one embodiment;

FIG. 3 is a flowchart of a process for attributing and apply reward credits by the online learning platform of FIG. 1, according to one embodiment;

FIG. 4 is a flowchart of a process for determining skill mastery points and qualification for career placement by the online learning platform of FIG. 1, according to one embodiment;

FIG. 5 is a diagram of the system architecture of an online learning platform, according to one embodiment;

FIG. 6 is a diagram of the interaction between the user side application and the database/server of the online learning platform of FIG. 1, according to one embodiment;

FIG. 7 is a diagram of the components of the online learning platform of FIG. 1 executing the processes associated with determining student performance, according to one embodiment;

FIGS. 8-14 are diagrams of a graphical user interface (GUI) utilized by the online learning platform of FIG. 1, according to various example embodiments;

FIG. 15 is a diagram of hardware that can be used to implement various example embodiments;

FIG. 16 is a diagram of a chip set that can be used to implement various example embodiments; and

FIG. 17 is a diagram of a mobile terminal (e.g., handset) that can be used to implement various example embodiments.

### DESCRIPTION OF SOME EMBODIMENTS

Examples of a method, apparatus, and computer program for incentivizing online learning are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

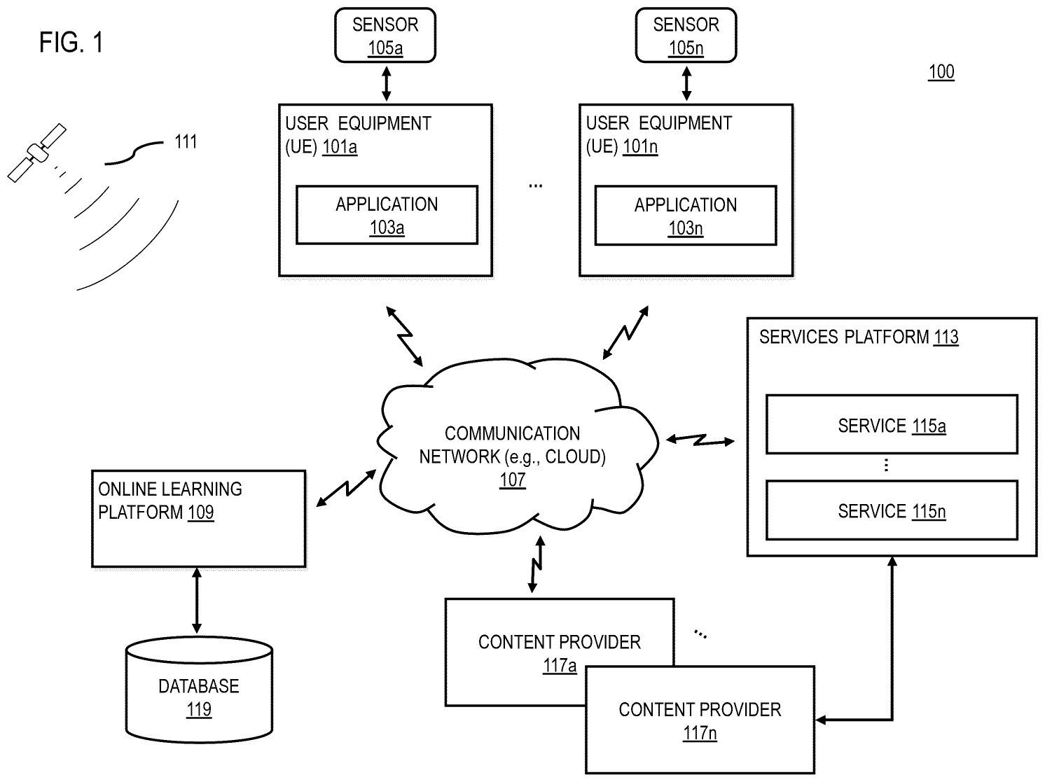

FIG. 1 is a diagram of online learning platform, according to one embodiment. To address the noted drawbacks of conventional systems and approaches to incentivizing users (e.g., students) seeking to learn course materials online, a system 100 of FIG. 1 includes an online learning platform that introduces the capability to assess a student's performance and skills mastery associated with a course and to attribute certain reward credits (e.g., monetary) based on such performance. In addition, the assessment can be utilized to assist with employment opportunities or career placement.

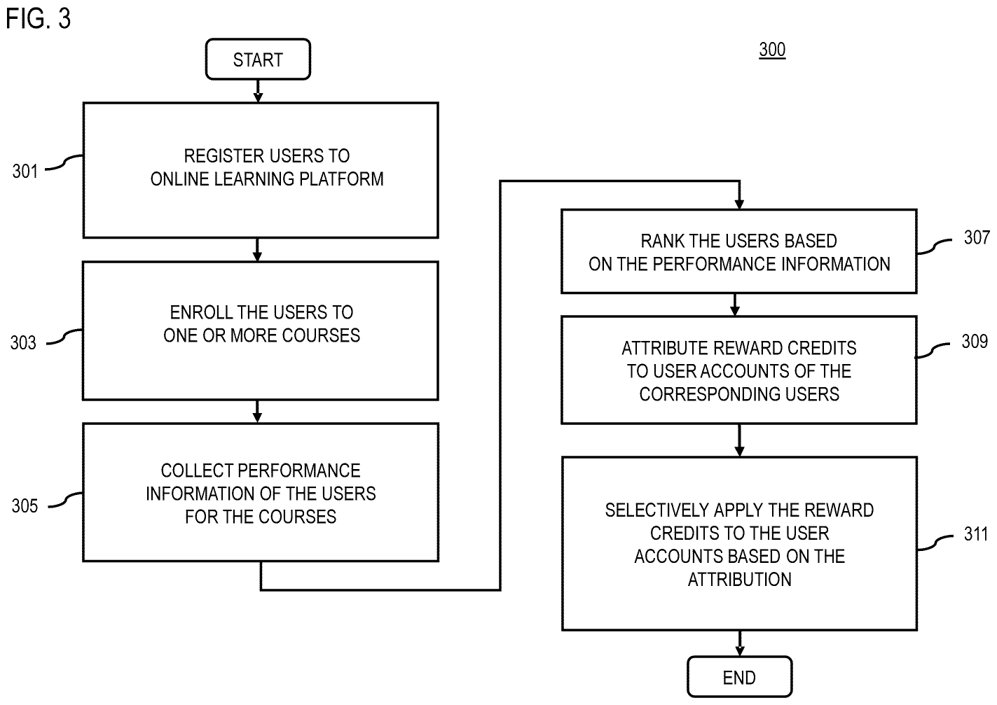

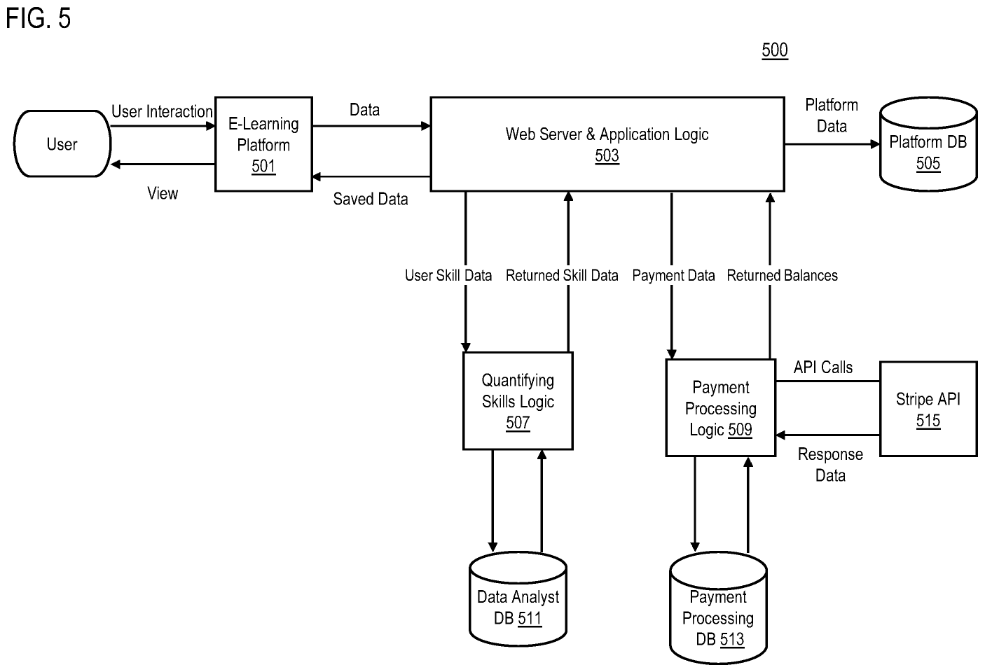

In one embodiment, the system 100 can be deployed using the architecture of FIG. 5, whereby the online learning platform 109 interacts with a web server or application logic, which operates with a quantifying skills logic and payment processing logic, to generate user skill data for providing payment to the students based on their performance with respect to the skills acquired during from the educational programs. Further details on the processes involved are explained in FIGS. 3, 4, and 7.

As shown in FIG. 1, the system 100 also comprises user equipment (UE) 101a-101n (collectively referred to as UE 101) that may include or be associated with applications 103a-103n (collectively referred to as applications 103) and sensors 105a-105n (collectively referred to as sensors 105). The sensors 105, in one embodiment, is a camera that captures images and/or video. In one embodiment, the UE 101 has connectivity to the online learning platform 109 via the communication network 107. The online learning platform 109 performs one or more functions associated with tracking student performance, and applying credit back on tuition or course fees in conjunction with the UEs 101a-101n.

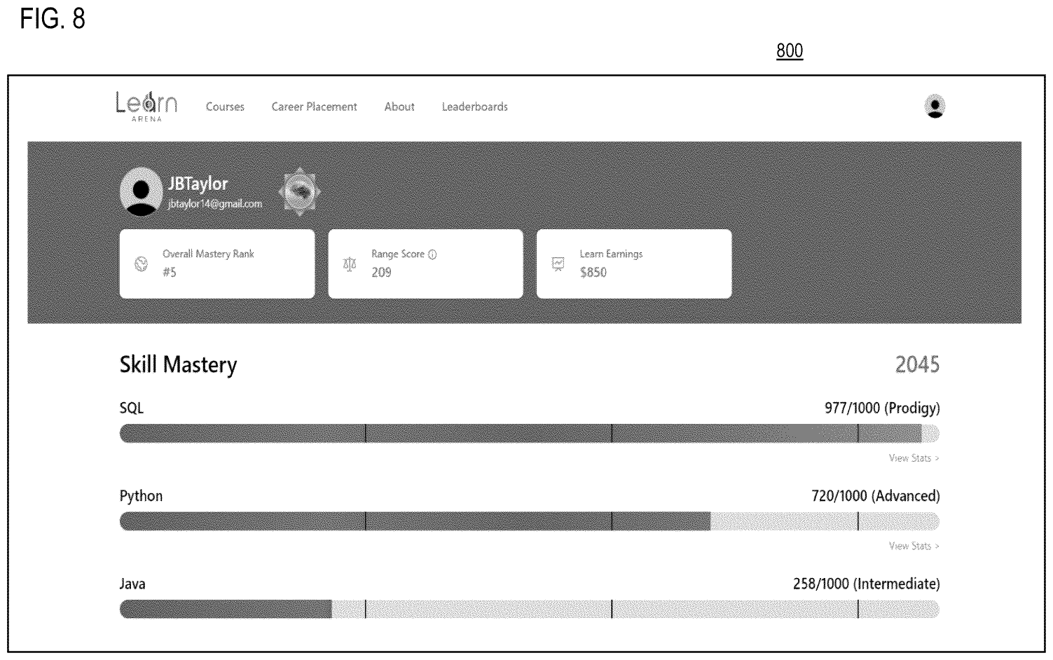

By way of example, the UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, a smartphone, a smartwatch, smart eyewear, or any combination thereof, including the accessories and peripherals of these devices, or any combination thereof. It is also contemplated that the UE 101 can support any type of interface to the user (such as “wearable” circuitry, etc.). In one embodiment, the UE 101 may include Global Positioning System (GPS) receivers to obtain geographic coordinates from satellites 111 for determining current location and time associated with the UE 101; such GPS information can be utilized to geo-tag images captured by the sensors. The UE 101 is capable of supporting a graphical user interface (GUI) that provides the GUI of FIGS. 8-14.

The online learning platform 109 operates in conjunction with one or more applications resident on an UE 101. By way of example, the applications 103 may be any type of application that is executable at UE 101, such as content provisioning services, camera/imaging application, media player applications, social networking applications, calendar applications, and the like. In one embodiment, the applications 103 may assist in conveying sensor information via the communication network 107. In another embodiment, one of the applications 103 at the UE 101 may act as a client for the online learning platform 109 and perform one or more functions associated with the functions of the platform 113 by interacting with the platform 113 over the communication network 107.

The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including 5G (5th Generation), 4G, 3G, 2G, Long Term Evolution (LTE), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the online learning platform 109 may be a platform with multiple interconnected components. The online learning platform 109 may include multiple servers, intelligent networking devices, computing devices, components and corresponding software for providing real-time feedback based, at least in part, on analysis of sensor information. In addition, it is noted that the online learning platform 109 may be integrated or separated from services platform. Also, certain functionalities of the system 113 may reside within the UE 101 (e.g., as part of the applications 103).

As shown in FIG. 1, the platform 109 can interface a services platform 113, which provides various services, such as notification services, content (e.g., audio, video, images, etc.) provisioning services, application services, storage services, contextual information determination services, social networking services, location-based services, information-based services, etc. In one embodiment, the services platform 113 may interact with the UE 101, the online learning platform 109 and the content provider 117 to supplement or aid in the processing of the content information.

In the embodiment of FIG. 1, content providers 117a-117n (collectively referred to as content provider 117) may provide content to the UE 101, the online learning platform 109, and the services 115 of the services platform 113. The content provided may be any type of content, such as image content (e.g., pictures), textual content, audio content, video content, etc. In one embodiment, the content provider 117 may provide content that may supplement the content of the applications 103, the sensors 105, or a combination thereof. In another embodiment, the content provider 117 may also store content associated with the UE 101, the online learning platform 109, and the services 115 of the services platform 113. In a further embodiment, the content provider 117 may manage access to a central repository of data and offer a consistent, standard interface to data.

Associated with the online learning platform 109 is database 119. It is contemplated that database 119 can be implemented as a cloud storage system. In one embodiment, the database 119 stores sensor data as well as user/subscriber profile information.

By way of example, UE 101, the online learning platform 109, the services platform, and the content provider 117 communicate with each other and other components of the communication network 107 using well known, new or still developing protocols (e.g., IoT standards and protocols). In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

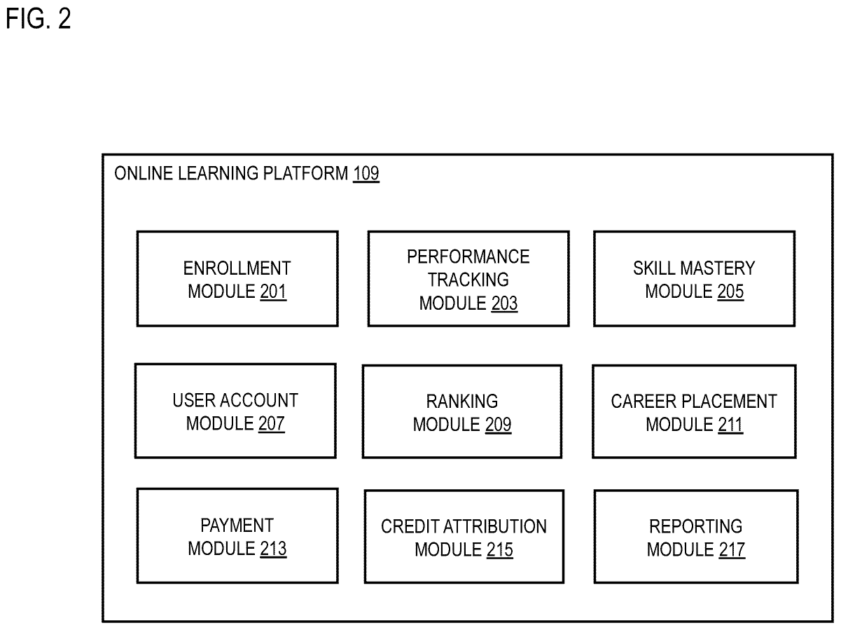

FIG. 2 is a diagram of the components of the online learning platform of FIG. 1, according to one embodiment. By way of example, the platform 109 includes one or more components for tracking student performance and providing reward credit (e.g., in form of cash) based on the performance. It is contemplated that the functions of these components may be combined in one or more components or performed by other components of equivalent functionality. In this embodiment, the online learning platform 109 includes the following modules: an enrollment module 201, a performance tracking module 203, a skill mastery module 205, a user account module 207, a ranking module 209, a career placement module 211, a payment module 213, a credit attribution module 215, and a reporting module 217.

The enrollment module 201 enables registering of users (i.e., students) in one or more particular course or educational program. Upon enrollment, the efforts of the students are tracked by the performance tracking module 203; for instance, grades and assignments are maintained for each of the students. Additionally, more significant indicators of skills and abilities can be assessed by the skill mastery module 205, which relies on a multitude of analytics on the users' interaction with testing applications for the courses. The user account module 207 manages information relating to various user accounts, which may include student account information, banking information, etc.; the module 207 provides data security measures to ensure the information is protected according to data privacy laws and regulations.

The ranking module 209, in one embodiment, generates a ranking score for each of the students for a particular course. It is contemplated that the ranking score can also be across all the courses, whereby an overall ranking score can be produced to identify a student with the best overall performance for a program (which comprises multiple courses). This module 209, along with the performance tracking module 203 and the skill mastery module 205, convey information (e.g., skill data) to the career placement module 211, which compares such information to criteria relating to employment. Reward credits are attributed accordingly by the credit attribution module 215.

The credit attribution module 215 provides information to the payment module 213 on how the reward credits for the students should be applied. The payment module 213 interacts with banking or other monetary systems to accurately and efficiently apply monetary credits to the students based on their performance and/or ranking.

The platform 109 also provides a reporting module 217, which can supply information or reports to the students of their standing and reward credits via the UE 101. The reporting can be real-time, according to one embodiment; such real-time information can provide more heightened awareness and motivation for the students.

A use case for incentivizing students is as follows. Under one scenario, students contributes or invest money to enter classes, then compete with the other students in a given class to earn back part of the money or investment (e.g., from 20% to 5× their investment) depending their performance rankings. Funds earned back, for example, can be reinvested into further classes or pulled off the platform. It is contemplated that the returned funds can be in other forms of assets in addition or instead of currency.

The payment module 213 can execute the following payout model (for illustrative purposes): students pay an investment fee, e.g., $15, to enroll in a class in which they have a certain period (e.g., 2 weeks) to review the class material and take the practice skill challenge tests. After all the students take the skill challenge (at a given time), their scores are percentile ranked against one another, and their accounts are credited with a reward credit (e.g., dollar amount) according to their ranking. According to one embodiment, the courses can be partitioned into multiple tiers, which may be differentiated by the level of difficulty of the course material; a user's tier can also dictate the level of reward the user can earn. In a top tier (e.g., tier 1) class, those students placing in the top percentile (e.g., 5%) would receive or be attributed a $30 credit; 5.1%-10% finishers would receive a $22.5 credit; 10.1-15% finishers would receive a $18.75 credit; 15.1-20% finishers would receive a credit of $15; 20.1-30% finishers would receive a credit of $7.5. The students who placed in the bottom percentile (e.g., 70%) that completed the class in the time allowed would receive the lowest credit, e.g., $3.

According to one embodiment, in addition to receiving a monetary reward credit, at the resolution of the class, each student will receive skill mastery points (as managed by the skill mastery module 205). The amount of skill mastery points available for any given student depends on the amount each student has already accrued; skill mastery points will be more difficult to earn as such points accumulate. In one embodiment, classes at higher tiers are associated with more skill mastery points that can be assigned to the students. Thus, as the students take classes and compete with their peers, their skills and abilities are quantified. For each student, the platform 109 quantifies what they know, how well they know it, how quick they are to learn new skills, as well as traits like conscientiousness, grit, ambition, aggressiveness, resourcefulness, etc. By way of example, such information can be made visible to the students, such as skill mastery for each subject. In one scenario, students can compete with one another in overall skill mastery; the platform 109 can present the leaderboard, via a GUI, indicating how a student compares against other top performing students. Top students are eligible to opt into our career placement program, where their profile and all of their platform data will be visible to hiring companies. The career placement module 211, in one embodiment, secures the requirements of these companies to vet out qualified candidates.

The above presented modules and components of the online learning platform 109 can be implemented in hardware, firmware, software, or a combination thereof. Though depicted as a separate entity in FIG. 1, it is contemplated that the online learning platform 109 may be implemented for direct operation by respective UE 101. As such, the online learning platform 109 may generate direct signal inputs by way of the operating system of the UE 101 for interacting with the applications 103. In another embodiment, one or more of the modules of FIG. 2 and processes of FIGS. 3, 4, and 7 may be implemented for operation by respective UEs, the online learning platform 109, or combination thereof. Still further, the online learning platform 109 may be integrated for direct operation with services 115, such as in the form of a widget or applet, in accordance with an information and/or subscriber sharing arrangement. The various executions presented herein contemplate any and all arrangements and models.

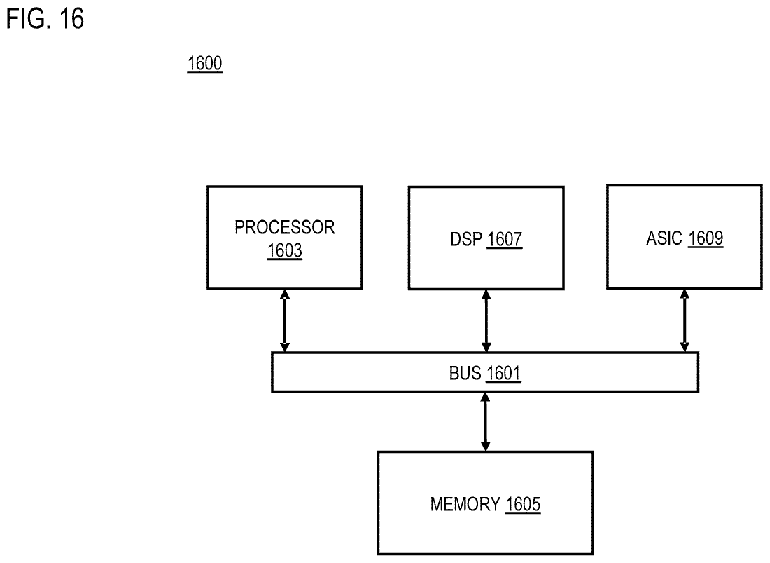

FIG. 3 is a flowchart of a process for attributing and apply reward credits by the online learning platform of FIG. 1, according to one embodiment. In one embodiment, the online learning platform 109 performs the process 300 and is implemented in, for instance, a chip set including a processor and a memory as shown in FIG. 16. As shown, per step 301, users (e.g., students) are registered to establish a corresponding plurality of user accounts. The students are then enrolled into one or more courses, per step 303. In step 305, performance information is collected for the users for the one or more courses. During participation in a course, various quizzes and tests are administered as well as any interact with an online course instructor (who can provide some assessment of the students as well); the quizzes and tests can be announced or unannounced. The data from these interactions are used to generate performance information. In step 307, the students are ranked based on the performance information. Using the ranking and/or performance information, reward credits (e.g., monetary credit) can be attributed to the students, as in step 309. Next, as in step 311, the reward credits are applied to the user accounts based on the attribution (for example, in the manner previous described—based on percentile ranking).

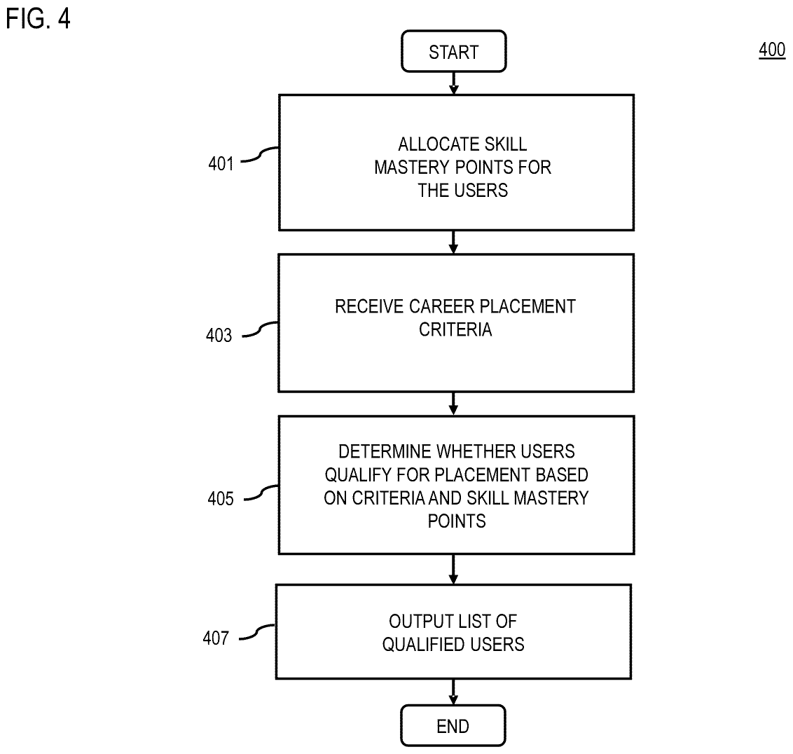

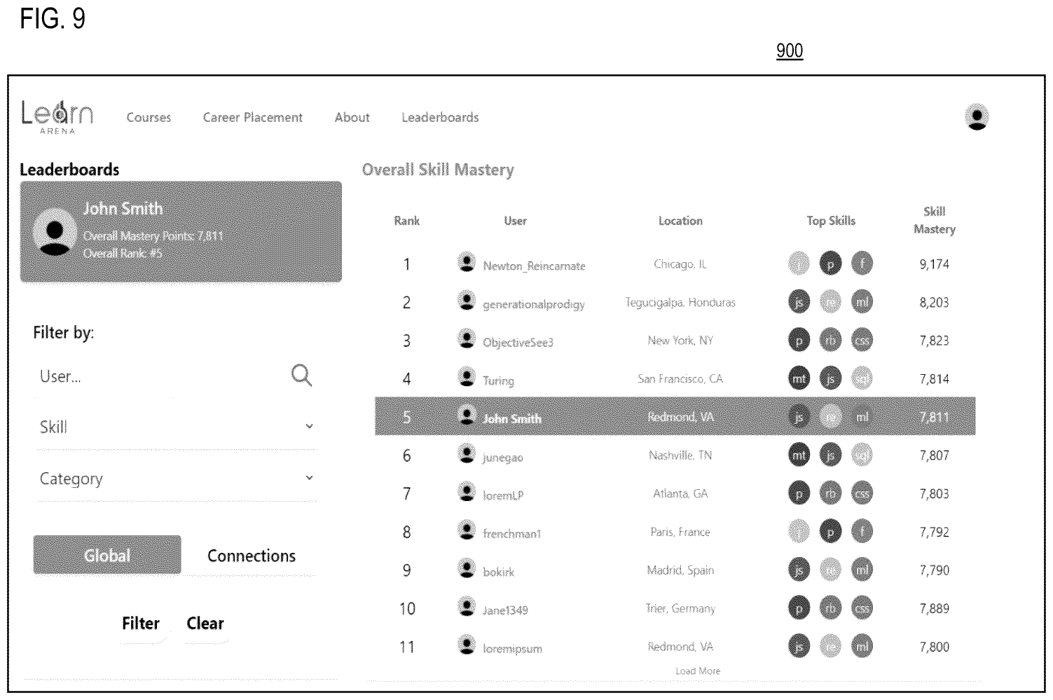

FIG. 4 is a flowchart of a process for determining skill mastery points and qualification for career placement by the online learning platform of FIG. 1, according to one embodiment. As previously explained, one capability of the platform 109 involves placement of students with employers. Per step 401, skill mastery points are generated/allocated according to the type of course and the performance of the student. The mastery points can be assigned to each of the users according to a ranked list, which can be accessible via the GUI of FIG. 9. The mastery points, in one embodiment, are weighted according to the difficulty level of the particular course.

To more accurately align employment candidates with the needs of potential employers, the platform 109 can receive career placement criteria from the employers (step 403); the platform 109 can provide such employers with a more granular set of possible parameters/performance metrics for these criteria than conventional approaches. In step 405, a determination is made with respect to which students qualify based on the receive criteria and the skill mastery points. A list of these qualified candidates can then be output and supplied to the potential employers (as in step 407). Under one scenario, a recommendation for job placement associated with a potential employer (which can be associated with the employer identification information) is generated for a particular user or group of users based on the ranked list.

FIG. 5 is a diagram of the system architecture of an online learning platform, according to one embodiment. Under this scenario, the architecture 500 represents the platform 109 (of FIG. 1) and can be implemented in a series of the illustrated components: e-learning platform 501; web server and application logic 503, platform database 505, quantifying skills logic 507, and payment processing logic 509. A data analyst database 511 interacts with the quantifying skills logic. A payment processing database 513 accompanies the payment processing logic, which is, for example, interfaced via a Stripe API (Application Programming Interface) 515.

The web platform 503 can present a variety of information via a GUI to the user; such as leaderboards, a profile page, a statistics page for each individual user, a course dashboard etc. (e.g., FIGS. 8-14). According to one embodiment, the payment system 509 running on, e.g., an Express Server integrating with the Stripe API 515 (which takes data about the results of each class and the corresponding payment due to each student and passes this information to Stripe) so that each student's account is credited by the amount they earned given their placing in the class and the parameters of that class (like the tier and the investment fee amount).

After, for instance, KYC checks and onboarding, the users are provided with a Connected Account to a Platform Account. This allows users to add funds to their account, pay for courses, and manage their account balance. Using Stripe's API for Connected Accounts, the platform 113 can manage balances; pay out the users by transferring available funds to their Connected Account, handling disputes, triggering post-payment events, etc.

The online learning platform 109 enables students to earn income, and possess functionality of a brokerage account. It is contemplated that students can visualize their earnings growth as well as skill mastery growth over time. The platform itself has the ability to support many programming terminals simultaneously, which is an advantage over conventional e-learning systems.

As described, with the payment system, students can invest funds from their account into a class or course. When the class is complete, funds are credited back out to students based upon their placement in the skill challenge. Each student receives a score for their performance on the skill challenge. For instance, these scores are percentile ranked against each other, and the percentile rank determines the amount of funds any given student will receive back. The amount of funds for a given percentile finish depends on the tier that the class is in, and is subject to refinement over time. Such ranking information can be provided to the students prior to their committing funds into the class. In one embodiment, every user is KYC'd and front-facing camera recording will ensure that data generated from a given account is authenticated—that is, coming from the student it purports to come from.

The platform 109 enables implementation of a “pokerfication” model, which accounts for percentile rank finishes and credits a certain amount back to each student's account. The amount credited is determined by parameters of the class like what tier it is in (and what the current payout structure for that tier is currently set to) and what the class investment fee is, as well as how highly the student placed. This “pokerfication” aspect of the platform 109 drives fierce competition and creates a talent pool. The platform 109 can measure the proclivities and performance of each student. Subsequently, a recruiting platform can provide recommendation for the highest performing students to be placed into jobs.

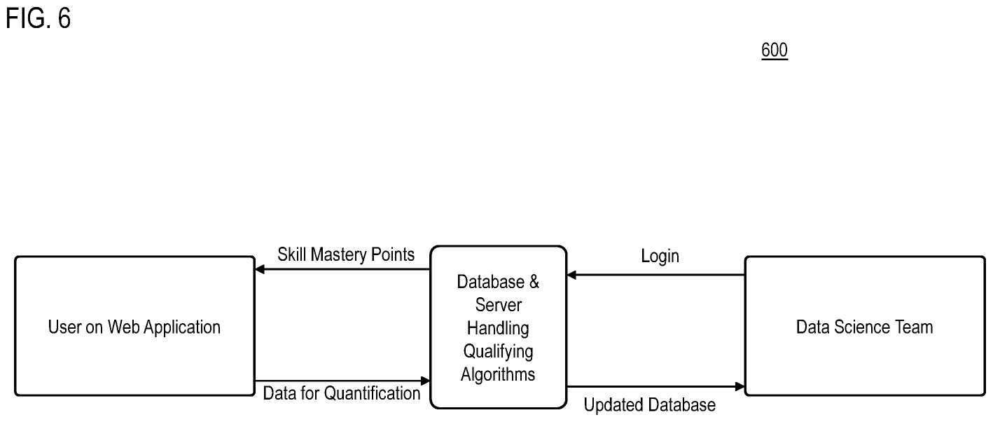

FIG. 6 is a diagram of the interaction between the user side application and the database/server of the online learning platform of FIG. 1, according to one embodiment. Under this scenario, a data science system 600 can access a database that maintains information about student performance data and skill data.

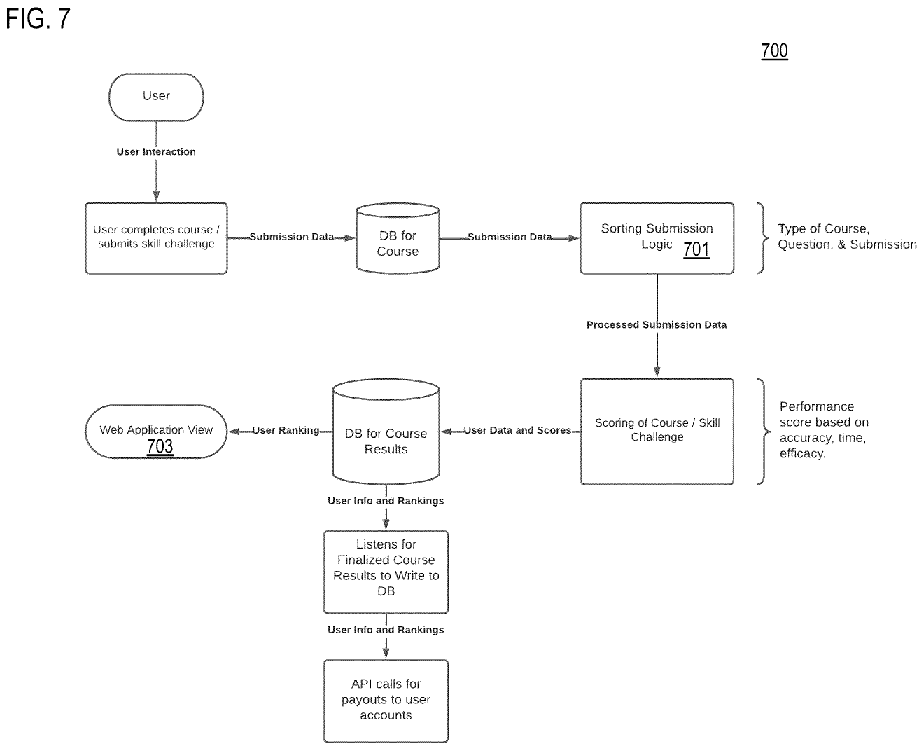

FIG. 7 is a diagram of the components of the online learning platform of FIG. 1 executing the processes associated with determining student performance, according to one embodiment. In this embodiment, system 700 (which can be implemented as part of the platform 109) includes sorting submission logic 701, which is utilized to process submission data associated with students' course work; for example, the type of course, questions, and submission are sorted. The processed submission data is supplied to logic relating to course scoring and skill challenge; the output (which includes user data and scoring information) can be accessed by the student user via a web application 703, for example. Additionally, the user information and ranking can be used to provide payouts to the student accounts.

FIGS. 8-14 are diagrams of a graphical user interface (GUI) utilized by the online learning platform of FIG. 1, according to various example embodiments. A User Profile Page 800 is provided in FIG. 8, in which a user (e.g., student) is provided with a display of the student's skill mastery with respect to various courses/topics. In this example, the subject matter includes programming skills in SQL, Python, and Java. The User Profile Page 800 can also display an overall mastery rank among all participating users (e.g., students), along with score and earnings.

FIG. 9 shows an example of a leaderboard page 900, showing the relative ranking of the students. This page 900 illustrates, by way of example, a list of top ranked users with their top skills relating to the courses they have participated in. The leaderboard page 900 provides a search capability based on, for instance, the user, skill, and category.

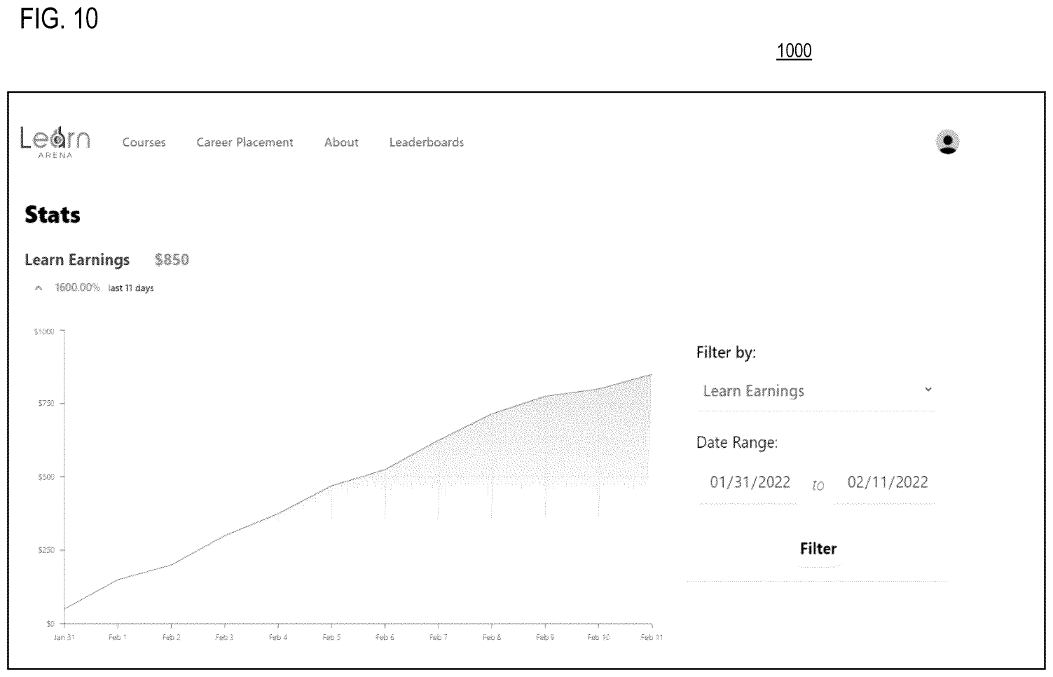

In FIG. 10, a Statistics Page 1000 is provided to present the student's reward credits (e.g., earnings). In this example, a graph of the user's earnings can be charted over a specified period of time, which can be set using the filter function as shown. The user's earnings, per this example, has demonstrated an 1600% increase in just 11 days. It is contemplated that various other statistical data can be displayed that may heighten the user's motivation or sense of competition (e.g., highest earners, speed of subject matter proficiency, etc.).

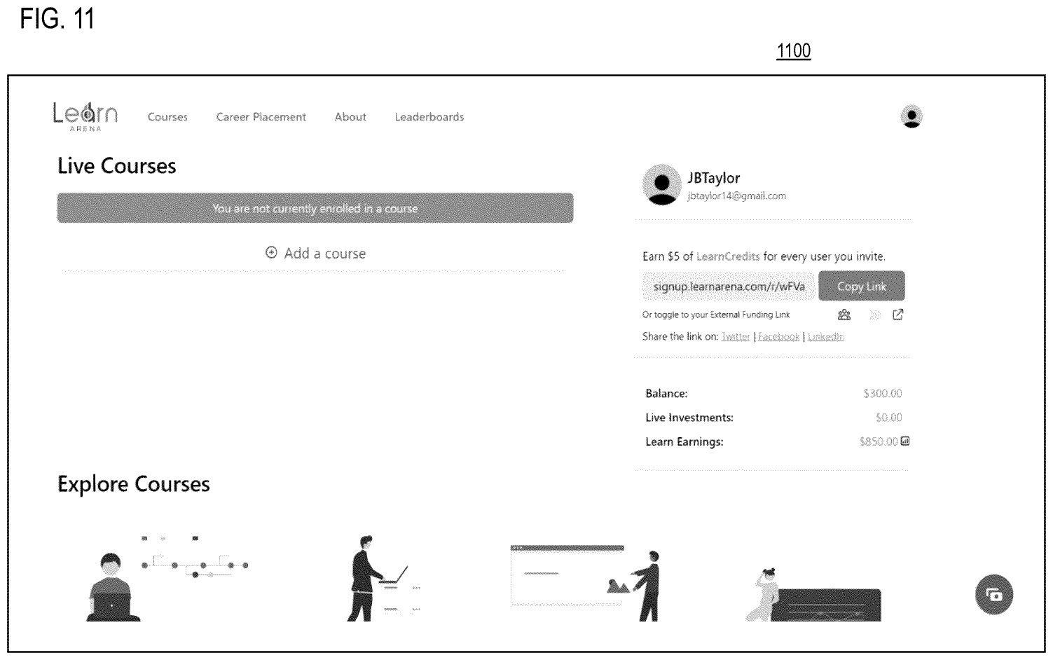

A Dashboard Page 1100, shown in FIG. 11, displays the various available courses. Under this embodiment, the user can view information relating to account balance, live investments, and learn earnings. It is noted that the courses can simply be created to promote search for a user with a particular skill that is desirable for a potential employer. That is, the platform 109 can create a competition to locate such user with a specific technical skill. As shown, the platform 109 can provide promotions such as enabling the user to invite other users to register with a $5 reward incentive.

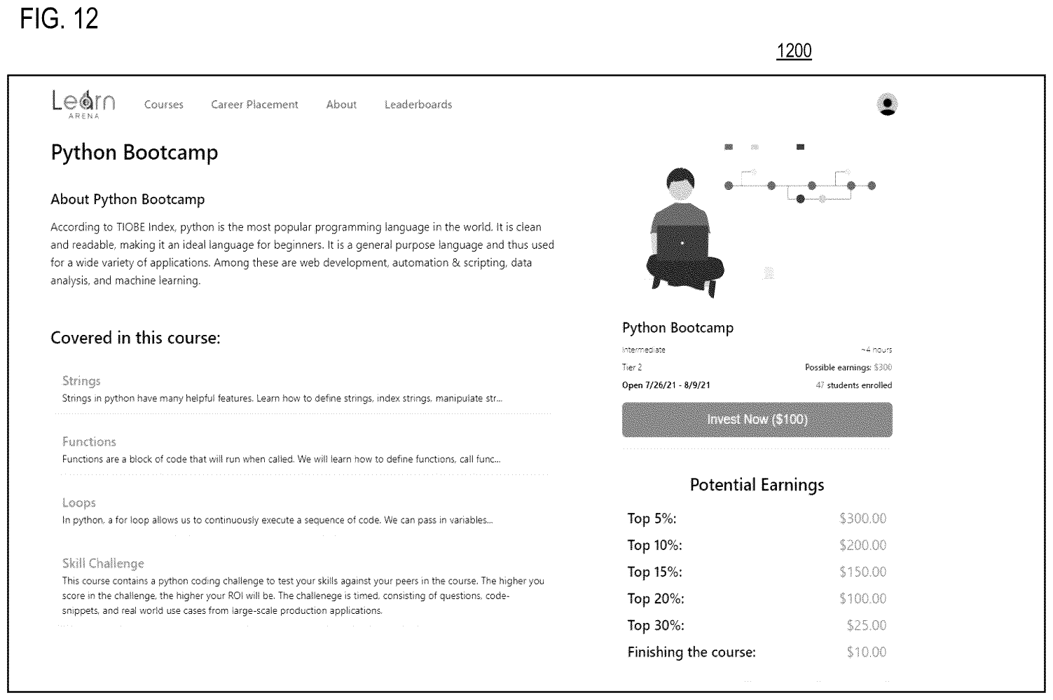

FIG. 12 illustrates more details of course information with the Course Overview Page 1200. Under this embodiment, the page 1200 displays a course description as well as the potential earnings if the student places within the various percentages. Additionally, the user can be allocated earnings for simply completing the course.

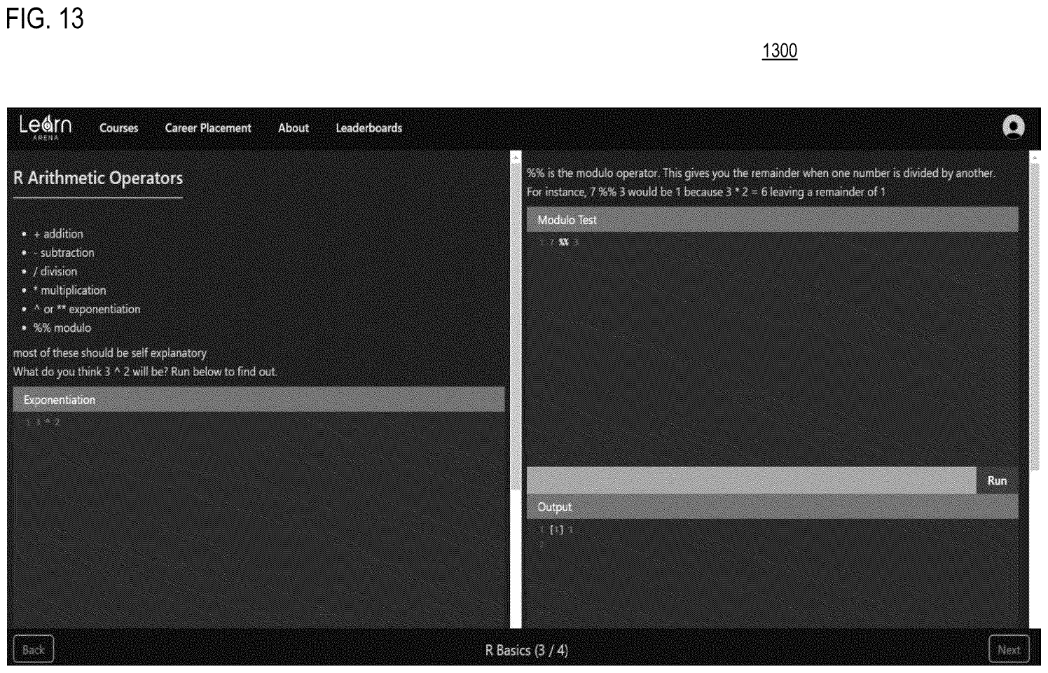

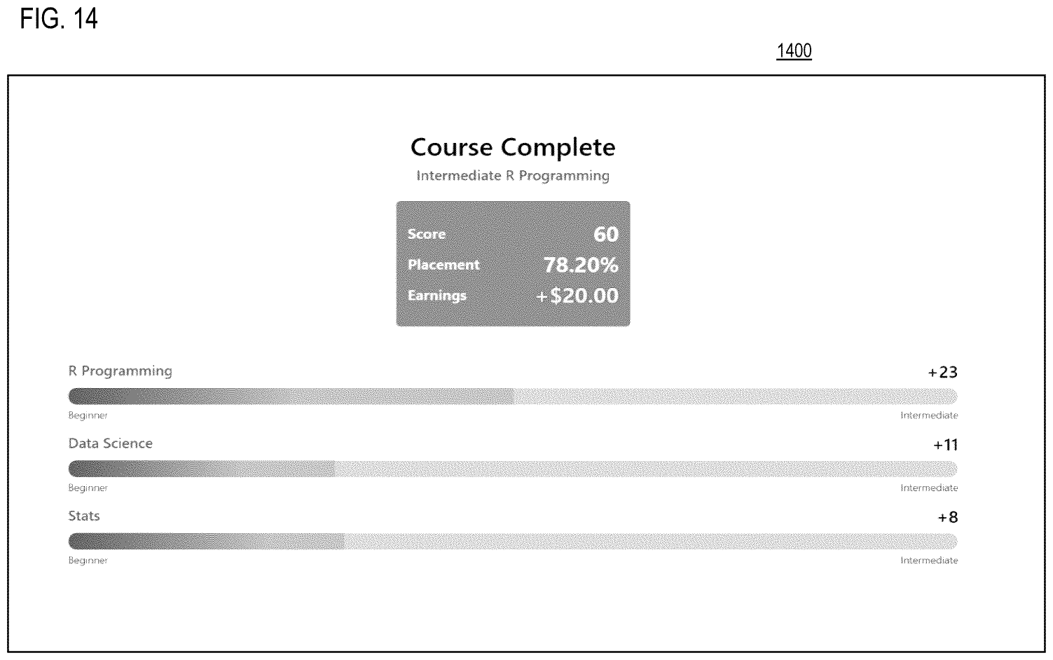

FIG. 13 provides a view 1300 of the operators that can be used to configure the online platform 113. FIG. 14 presents a GUI 1400 that provides information relating to course completion; namely, the score, percentage of placement (which indicates how well (or degree) of match with employment criteria), and earnings. The GUI can also permit students to compare performance statistics with other users, e.g., friends and family members.

The processes described herein for providing incentivized online learning may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

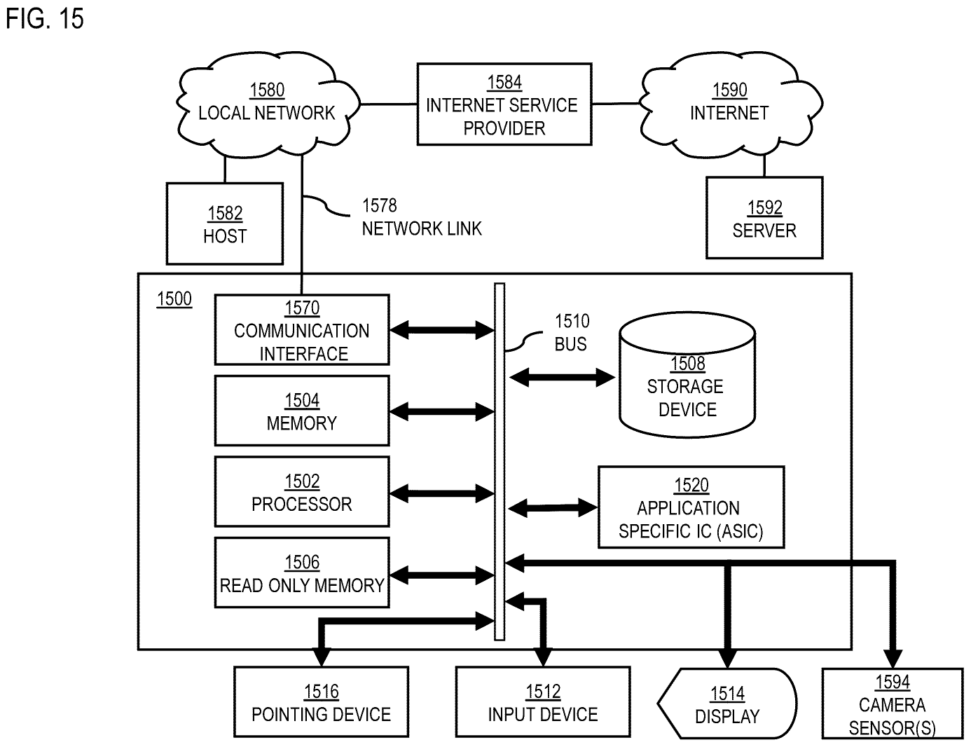

FIG. 15 illustrates a computer system 1500 upon which various embodiments of the invention may be implemented. Although computer system 1500 is depicted with respect to a particular device or equipment, it is contemplated that other devices or equipment (e.g., network elements, servers, etc.) within FIG. 15 can deploy the illustrated hardware and components of system 1500. Computer system 1500 is programmed (e.g., via computer program code or instructions) to incentivized online learning as described herein and includes a communication mechanism such as a bus 1510 for passing information between other internal and external components of the computer system 1500. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 1500, or a portion thereof, constitutes a means for performing one or more steps of the processes described herein, including those of FIGS. 3 and 4.

A bus 1510 includes one or more parallel conductors of information so that information is transferred quickly among devices coupled to the bus 1510. One or more processors 1502 for processing information are coupled with the bus 1510.

A processor (or multiple processors) 1502 performs a set of operations on information as specified by computer program code related to incentivizing online learning. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 1510 and placing information on the bus 1510. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 1502, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 1500 also includes a memory 1504 coupled to bus 1510. The memory 1504, such as a random access memory (RAM) or any other dynamic storage device, stores information including processor instructions for providing real-time feedback during a golf play based, at least in part, on analysis of sensor information. Dynamic memory allows information stored therein to be changed by the computer system 1500. RAM allows a unit of information stored at a location called a memory address to be stored and retrieved independently of information at neighboring addresses. The memory 1504 is also used by the processor 1502 to store temporary values during execution of processor instructions. The computer system 1500 also includes a read only memory (ROM) 1506 or any other static storage device coupled to the bus 1510 for storing static information, including instructions, that is not changed by the computer system 1500. Some memory is composed of volatile storage that loses the information stored thereon when power is lost. Also coupled to bus 1510 is a non-volatile (persistent) storage device 1508, such as a magnetic disk, optical disk or flash card, for storing information, including instructions, that persists even when the computer system 1500 is turned off or otherwise loses power.

Information, including instructions for providing a real-time feedback during a golf play based, at least in part, on analysis of sensor information, is provided to the bus 1510 for use by the processor from an external input device 1512, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 1500. Other external devices coupled to bus 1510, used primarily for interacting with humans, include a display device 1514, such as a vacuum fluorescent display (VFD), a liquid crystal display (LCD), a light-emitting diode (LED), an organic light-emitting diode (OLED), a quantum dot display, a virtual reality (VR) headset, a plasma screen, a cathode ray tube (CRT), or a printer for presenting text or images, and a pointing device 1516, such as a mouse, a trackball, cursor direction keys, or a motion sensor, for controlling a position of a small cursor image presented on the display 1514 and issuing commands associated with graphical elements presented on the display 1514, and one or more camera sensors 1594 for capturing, recording and causing to store one or more still and/or moving images (e.g., videos, movies, etc.) which also may comprise audio recordings. In some embodiments, for example, in embodiments in which the computer system 1500 performs all functions automatically without human input, one or more of external input device 1512, a display device 1514 and pointing device 1516 may be omitted.

In the illustrated embodiment, special purpose hardware, such as an application specific integrated circuit (ASIC) 1520, is coupled to bus 1510. The special purpose hardware is configured to perform operations not performed by processor 1502 quickly enough for special purposes. Examples of ASICs include graphics accelerator cards for generating images for display 1514, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 1500 also includes one or more instances of a communications interface 1570 coupled to bus 1510. Communication interface 1570 provides a one-way or two-way communication coupling to a variety of external devices that operate with their own processors, such as printers, scanners, and external disks. In general, the coupling is with a network link 1578 that is connected to a local network 1580 to which a variety of external devices with their own processors are connected. For example, communication interface 1570 may be a parallel port or a serial port or a universal serial bus (USB) port on a personal computer. In some embodiments, communications interface 1570 is an integrated services digital network (ISDN) card or a digital subscriber line (DSL) card or a telephone modem that provides an information communication connection to a corresponding type of telephone line. In some embodiments, a communication interface 1570 is a cable modem that converts signals on bus 1510 into signals for a communication connection over a coaxial cable or into optical signals for a communication connection over a fiber optic cable. As another example, communications interface 1570 may be a local area network (LAN) card to provide a data communication connection to a compatible LAN, such as Ethernet. Wireless links may also be implemented. For wireless links, the communications interface 1570 sends or receives or both sends and receives electrical, acoustic or electromagnetic signals, including infrared and optical signals, that carry information streams, such as digital data. For example, in wireless handheld devices, such as mobile telephones like cell phones, the communications interface 1570 includes a radio band electromagnetic transmitter and receiver called a radio transceiver. In certain embodiments, the communications interface 1570 enables connection to the communication network 157 for providing real-time feedback during a golf play based, at least in part, on analysis of sensor information to the UE 151.

The term “computer-readable medium” as used herein refers to any medium that participates in providing information to processor 1502, including instructions for execution. Such a medium may take many forms, including, but not limited to a computer-readable storage medium (e.g., non-volatile media, volatile media), and transmission media. Non-transitory media, such as non-volatile media, include, for example, optical or magnetic disks, such as storage device 1508. Volatile media include, for example, dynamic memory 1504. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 1520.

Network link 1578 typically provides information communication using transmission media through one or more networks to other devices that use or process the information. For example, network link 1578 may provide a connection through local network 1580 to a host computer 1582 or to equipment 1584 operated by an Internet Service Provider (ISP). ISP equipment 1584 in turn provides data communication services through the public, world-wide packet-switching communication network of networks now commonly referred to as the Internet 1590.

A computer called a server host 1592 connected to the Internet hosts a process that provides a service in response to information received over the Internet. For example, server host 1592 hosts a process that provides information representing video data for presentation at display 1514. It is contemplated that the components of system 1500 can be deployed in various configurations within other computer systems, e.g., host 1582 and server 1592.

At least some embodiments of the invention are related to the use of computer system 1500 for implementing some or all of the techniques described herein. According to one embodiment of the invention, those techniques are performed by computer system 1500 in response to processor 1502 executing one or more sequences of one or more processor instructions contained in memory 1504. Such instructions, also called computer instructions, software and program code, may be read into memory 1504 from another computer-readable medium such as storage device 1508 or network link 1578. Execution of the sequences of instructions contained in memory 1504 causes processor 1502 to perform one or more of the method steps described herein. In alternative embodiments, hardware, such as ASIC 1520, may be used in place of or in combination with software to implement the invention. Thus, embodiments of the invention are not limited to any specific combination of hardware and software, unless otherwise explicitly stated herein.

The signals transmitted over network link 1578 and other networks through communications interface 1570, carry information to and from computer system 1500. Computer system 1500 can send and receive information, including program code, through the networks 1580, 1590 among others, through network link 1578 and communications interface 1570. In an example using the Internet 1590, a server host 1592 transmits program code for a particular application, requested by a message sent from computer 1500, through Internet 1590, ISP equipment 1584, local network 1580 and communications interface 1570. The received code may be executed by processor 1502 as it is received, or may be stored in memory 1504 or in storage device 1508 or any other non-volatile storage for later execution, or both. In this manner, computer system 1500 may obtain application program code in the form of signals on a carrier wave.

Various forms of computer readable media may be involved in carrying one or more sequence of instructions or data or both to processor 1502 for execution. For example, instructions and data may initially be carried on a magnetic disk of a remote computer such as host 1582. The remote computer loads the instructions and data into its dynamic memory and sends the instructions and data over a telephone line using a modem. A modem local to the computer system 1500 receives the instructions and data on a telephone line and uses an infra-red transmitter to convert the instructions and data to a signal on an infra-red carrier wave serving as the network link 1578. An infrared detector serving as communications interface 1570 receives the instructions and data carried in the infrared signal and places information representing the instructions and data onto bus 1510. Bus 1510 carries the information to memory 1504 from which processor 1502 retrieves and executes the instructions using some of the data sent with the instructions. The instructions and data received in memory 1504 may optionally be stored on storage device 1508, either before or after execution by the processor 1502.

FIG. 16 illustrates a chip set or chip 1600 upon which various embodiments of the invention may be implemented. Chip set 1600 is programmed to the processes (e.g., FIGS. 3 and 4) as described herein and includes, for instance, the processor and memory components described with respect to FIG. 15 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1600 can be implemented in a single chip. It is further contemplated that in certain embodiments the chip set or chip 1600 can be implemented as a single “system on a chip.” It is further contemplated that in certain embodiments a separate ASIC would not be used, for example, and that all relevant functions as disclosed herein would be performed by a processor or processors. Chip set or chip 1600, or a portion thereof, constitutes a means for performing one or more steps of providing user interface navigation information associated with the availability of functions. Chip set or chip 1600, or a portion thereof, constitutes a means for performing one or more steps of providing incentives for online learning.

In one embodiment, the chip set or chip 1600 includes a communication mechanism such as a bus 1601 for passing information among the components of the chip set 1600. A processor 1603 has connectivity to the bus 1601 to execute instructions and process information stored in, for example, a memory 1605. The processor 1603 may include one or more processing cores with each core configured to perform independently. A multi-core processor enables multiprocessing within a single physical package. Examples of a multi-core processor include two, four, eight, or greater numbers of processing cores. Alternatively or in addition, the processor 1603 may include one or more microprocessors configured in tandem via the bus 1601 to enable independent execution of instructions, pipelining, and multithreading. The processor 1603 may also be accompanied with one or more specialized components to perform certain processing functions and tasks such as one or more digital signal processors (DSP) 1607, or one or more application-specific integrated circuits (ASIC) 1609. A DSP 1607 typically is configured to process real-world signals (e.g., sound) in real time independently of the processor 1603. Similarly, an ASIC 1609 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1600 includes merely one or more processors and some software and/or firmware supporting and/or relating to and/or for the one or more processors.

The processor 1603 and accompanying components have connectivity to the memory 1605 via the bus 1601. The memory 1605 includes both dynamic memory (e.g., RAM, magnetic disk, writable optical disk, etc.) and static memory (e.g., ROM, CD-ROM, etc.) for storing executable instructions that when executed perform the inventive steps described herein to provide incentivizing online learning. The memory 1605 also stores the data associated with or generated by the execution of the inventive steps.

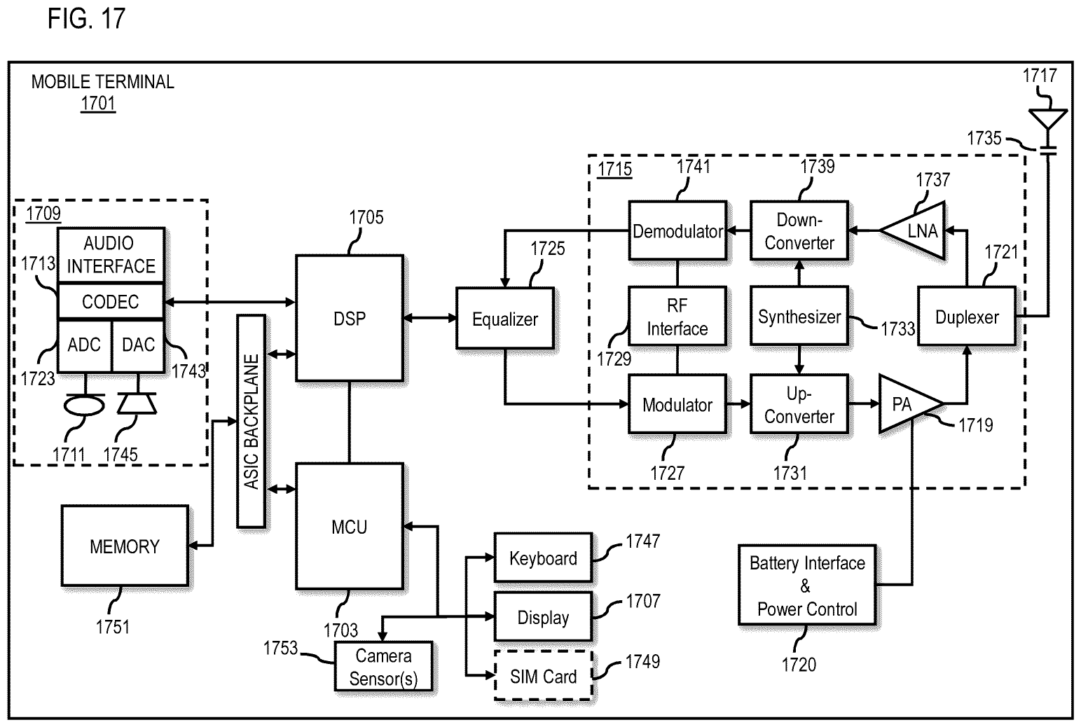

FIG. 17 is a diagram of exemplary components of a mobile terminal (e.g., handset) for communications, which is capable of operating in the system of FIG. 1, according to one embodiment. In some embodiments, mobile terminal 1701, or a portion thereof, constitutes a means for performing one or more steps of the described processes. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1703, a Digital Signal Processor (DSP) 1705, and a receiver/transmitter unit including a microphone gain control unit and a speaker gain control unit. A main display unit 1707 provides a display to the user in support of various applications and mobile terminal functions that perform or support the steps of incentivizing online learning. The display 1707 includes display circuitry configured to display at least a portion of a user interface of the mobile terminal (e.g., mobile telephone). Additionally, the display 1707 and display circuitry are configured to facilitate user control of at least some functions of the mobile terminal. An audio function circuitry 1709 includes a microphone 1711 and microphone amplifier that amplifies the speech signal output from the microphone 1711. The amplified speech signal output from the microphone 1711 is fed to a coder/decoder (CODEC) 1713.

A radio section 1715 amplifies the power and converts frequency in order to communicate with a base station, which is included in a mobile communication system, via antenna 1717. The power amplifier (PA) 1719 and the transmitter/modulation circuitry are operationally responsive to the MCU 1703, with an output from the PA 1719 coupled to the duplexer 1721 or circulator or antenna switch, as known in the art. The PA 1719 also couples to a battery interface and power control unit 1720.

In use, a user of mobile terminal 1701 speaks into the microphone 1711 and his or her voice along with any detected background noise is converted into an analog voltage. The analog voltage is then converted into a digital signal through the Analog to Digital Converter (ADC) 1723. The control unit 1703 routes the digital signal into the DSP 1705 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1725 for compensation of any frequency-dependent impairments that occur during transmission though the air such as phase and amplitude distortion. After equalizing the bit stream, the modulator 1727 combines the signal with an RF signal generated in the RF interface 1729. The modulator 1727 generates a sine wave by way of frequency or phase modulation. In order to prepare the signal for transmission, an up-converter 1731 combines the sine wave output from the modulator 1727 with another sine wave generated by a synthesizer 1733 to achieve the desired frequency of transmission. The signal is then sent through a PA 1719 to increase the signal to an appropriate power level. In practical systems, the PA 1719 acts as a variable gain amplifier whose gain is controlled by the DSP 1705 from information received from a network base station. The signal is then filtered within the duplexer 1721 and optionally sent to an antenna coupler 1735 to match impedances to provide maximum power transfer. Finally, the signal is transmitted via antenna 1717 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1701 are received via antenna 1717 and immediately amplified by a low noise amplifier (LNA) 1737. A down-converter 1739 lowers the carrier frequency while the demodulator 1741 strips away the RF leaving only a digital bit stream. The signal then goes through the equalizer 1725 and is processed by the DSP 1705. A Digital to Analog Converter (DAC) 1743 converts the signal and the resulting output is transmitted to the user through the speaker 1745, all under control of a Main Control Unit (MCU) 1703 which can be implemented as a Central Processing Unit (CPU).

The MCU 1703 receives various signals including input signals from the keyboard 1747. The keyboard 1747 and/or the MCU 1703 in combination with other user input components (e.g., the microphone 1711) comprise a user interface circuitry for managing user input. The MCU 1703 runs a user interface software to facilitate user control of at least some functions of the mobile terminal 1701 to incentivize online learning. The MCU 1703 also delivers a display command and a switch command to the display 1707 and to the speech output switching controller, respectively. Further, the MCU 1703 exchanges information with the DSP 1705 and can access an optionally incorporated SIM card 1749 and a memory 1751. In addition, the MCU 1703 executes various control functions required of the terminal. The DSP 1705 may, depending upon the implementation, perform any of a variety of conventional digital processing functions on the voice signals. Additionally, DSP 1705 determines the background noise level of the local environment from the signals detected by microphone 1711 and sets the gain of microphone 1711 to a level selected to compensate for the natural tendency of the user of the mobile terminal 1701.

The CODEC 1713 includes the ADC 1723 and DAC 1743. The memory 1751 stores various data including call incoming tone data and is capable of storing other data including music data received via, e.g., the global Internet. The software module could reside in RAM memory, flash memory, registers, or any other form of writable storage medium known in the art. The memory device 1751 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1749 carries, for instance, important information, such as the cellular phone number, the carrier supplying service, subscription details, and security information. The SIM card 1749 serves primarily to identify the mobile terminal 1701 on a radio network. The card 1749 also contains a memory for storing a personal telephone number registry, text messages, and user specific mobile terminal settings.

Further, one or more camera sensors 1753 may be incorporated onto the mobile station 1701 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
registering a plurality of users to establish a corresponding plurality of user accounts;
enrolling the plurality of users into one or more courses;
collecting performance information of the plurality of users for the one or more courses;
determining ranking of the plurality of users based on the performance information;
attributing reward credits to one or more of the plurality users according to the ranking; and
selectively applying the reward credits to the plurality of user accounts based on the attribution.

2. The method of claim 1, further comprising:
generating mastery points for the one or more courses based on the performance information;
assigning the mastery points to each of the plurality of users according to a ranked list; and
providing access to the ranked list for presentation via a graphical user interface.

3. The method of claim 2, further comprising:
determining difficulty level of the one or more courses, wherein the mastery points are weighted according to the determined difficulty level.

4. The method of claim 2, further comprising:
retrieving employer identification information corresponding to one of a plurality of potential employer organizations; and
generating a recommendation for job placement associated with the employer identification information for a particular one or more of the plurality of users based on the ranked list.

5. The method of claim 2, further comprising:
generating a dashboard for presentation, via a graphical user interface, to the plurality of users, wherein the dashboard provides cumulative historical information relating to the performance information, the applied reward credits, and the mastery points.

6. The method of claim 1, further comprising:
partitioning the reward credits into a plurality of tiers, wherein the plurality of tiers correspond to different levels of the attribution of the reward credits and correspond to difficulty of the courses, wherein the reward credits include monetary awards.

7. The method of claim 1, further comprising:
tracking statistical information for each of the plurality of users, wherein the statistical information relates to type of course, length of study time for a particular course, investment in the particular course, and/or time to complete the particular course.

8. A system comprising:
a memory configured to store computer-executable instructions; and
one or more processors configured to execute the instructions to:
register a plurality of users to establish a corresponding plurality of user accounts;
enroll the plurality of users into one or more courses;
collect performance information of the plurality of users for the one or more courses;
determine ranking of the plurality of users based on the performance information;
attribute reward credits to one or more of the plurality users according to the ranking; and
selectively apply the reward credits to the plurality of user accounts based on the attribution.

9. The system of claim 8, wherein the one or more processors are further configured to execute the instructions to:
generate mastery points for the one or more courses based on the performance information;
assign the mastery points to each of the plurality of users according to a ranked list; and
provide access to the ranked list for presentation via a graphical user interface.

10. The system of claim 9, wherein the one or more processors are further configured to execute the instructions to:
determine difficulty level of the one or more courses, wherein the mastery points are weighted according to the determined difficulty level.

11. The system of claim 9, wherein the one or more processors are further configured to execute the instructions to:
retrieve employer identification information corresponding to one of a plurality of potential employer organizations; and
generate a recommendation for job placement associated with the employer identification information for a particular one or more of the plurality of users based on the ranked list.

12. The system of claim 9, wherein the one or more processors are further configured to execute the instructions to:
generate a dashboard for presentation, via a graphical user interface, to the plurality of users, wherein the dashboard provides cumulative historical information relating to the performance information, the applied reward credits, and the mastery points.

13. The system of claim 8, wherein the one or more processors are further configured to execute the instructions to:
partition the reward credits into a plurality of tiers, wherein the plurality of tiers correspond to different levels of the attribution of the reward credits and correspond to difficulty of the courses, wherein the reward credits include monetary awards.

14. The system of claim 8, wherein the one or more processors are further configured to execute the instructions to:
track statistical information for each of the plurality of users, wherein the statistical information relates to type of course, length of study time for a particular course, investment in the particular course, and/or time to complete the particular course.

15. A non-transitory computer-readable storage medium carrying one or more sequences of one or more instructions which, when executed by one or more processors, cause an apparatus to perform:
a memory configured to store computer-executable instructions; and
one or more processors configured to execute the instructions to:
register a plurality of users to establish a corresponding plurality of user accounts;
enroll the plurality of users into one or more courses;
collect performance information of the plurality of users for the one or more courses;
determine ranking of the plurality of users based on the performance information;
attribute reward credits to one or more of the plurality users according to the ranking; and
selectively apply the reward credits to the plurality of user accounts based on the attribution.

16. The non-transitory computer-readable storage medium of claim 15, wherein the apparatus is further configured to execute the instructions to:
generate mastery points for the one or more courses based on the performance information;
assign the mastery points to each of the plurality of users according to a ranked list; and
provide access to the ranked list for presentation via a graphical user interface.

17. The non-transitory computer-readable storage medium of claim 16, wherein the apparatus is further configured to execute the instructions to:
determine difficulty level of the one or more courses, wherein the mastery points are weighted according to the determined difficulty level.

18. The non-transitory computer-readable storage medium of claim 16, wherein the apparatus is further configured to execute the instructions to:
retrieve employer identification information corresponding to one of a plurality of potential employer organizations; and
generate a recommendation for job placement associated with the employer identification information for a particular one or more of the plurality of users based on the ranked list.

19. The non-transitory computer-readable storage medium of claim 16, wherein the apparatus is further configured to execute the instructions to:
generate a dashboard for presentation, via a graphical user interface, to the plurality of users, wherein the dashboard provides cumulative historical information relating to the performance information, the applied reward credits, and the mastery points.

20. The non-transitory computer-readable storage medium of claim 15, wherein the apparatus is further configured to execute the instructions to:
partition the reward credits into a plurality of tiers, wherein the plurality of tiers correspond to different levels of the attribution of the reward credits and correspond to difficulty of the courses, wherein the reward credits include monetary awards.
